(19) United States
(12) Patent Application Publication
(10) Pub. No.: US 2026/0326391 A1
(43) Pub. Date: Oct. 22, 2026

(54) SYSTEM AND METHOD FOR MAKING A BATTERY TRAY ASSEMBLY

(71) Applicant: MAGNA INTERNATIONAL INC., Aurora (CA)

(72) Inventors: Richard McALPINE, Port Huron, MI (US); Colin THOMPSON, Port Huron, MI (US); Miles WARD, Gaines, MI (US); David McCURDY, Chesterfield, MI (US)

(21) Appl. No.: 19/692,311

(22) Filed: May 29, 2026

Related U.S. Application Data
(63) Continuation-in-part of application No. PCT/US2024/057752, filed on Nov. 27, 2024.
(60) Provisional application No. 63/603,893, filed on Nov. 29, 2023.

(51) Int. Cl. B29C 65/48; B29C 65/00; B29L 31/00; H01M 10/04; H01M 50/249

(52) U.S. Cl. CPC B29C 65/4825; B29C 66/81264; H01M 10/0481; H01M 50/249; B29L 2031/7146

(57) ABSTRACT

A method for making a tray assembly includes positioning a first component adjacent to a second component. The second component has a lower portion positioned adjacent to the first component and an upper portion spaced from the first component. A top surface of the lower portion is positioned below a top surface of the first component, and a top surface of the upper portion is adjacent to the top surface of the first component such that a gap is defined along the lower portion of the second component beneath the top surfaces of the first component and the upper portion of the second component. The method includes filling the gap with an adhesive and then compressing a pad toward the adhesive such that a continuous top surface of the adhesive extends between the top surfaces of the first component and the upper portion of the second component.

### CROSS-REFERENCE TO RELATED APPLICATIONS

This Bypass Continuation-in-Part Patent Application claims the benefit of, and priority to, PCT International Patent Application PCT/US2024/057752 filed on Nov. 27, 2024, which claims the benefit of, and priority to U.S. Provisional Patent Application Ser. No. 63/603,893 filed on Nov. 29, 2023, the entire disclosures of which are hereby incorporated by reference.

### BACKGROUND OF THE DISCLOSURE

### 1. Field of the Disclosure

The present disclosure relates to battery trays for holding and protecting batteries of electric vehicles.

### 2. Related Art

This section provides background information related to the present disclosure which is not necessarily prior art.

It is known for electric vehicles to include tray assemblies for holding and protecting batteries. Tray assemblies typically have a flat base surrounded by upwardly projecting walls and rounded corner segments. It is known to fill and seal a gap between upper flanges of the walls and corner segments via an adhesive by way of a manual skiving process. More particularly, the manual skiving process typically entails positioning the adhesive in the gap, then applying pressure to the adhesive in a sweeping motion with a tongue depressor, or similar tool to fill the gap. Edges of the adhesive are then feathered with the tongue depressor to provide a smooth transition to the metal surfaces on sides of the gap.

Issues with such adhesive connections include a lack of material flushness, sagging of the adhesive, leaking through the gap, and complexities for operators to perform the manual skiving operation. Accordingly, there remains a need for improvements to tray assemblies and methods for making the same.

### SUMMARY OF THE DISCLOSURE

A method for making a tray assembly includes providing a first component and a second component. The first component is positioned adjacent to the second component. The second component has a lower portion positioned adjacent to the first component and an upper portion spaced from the first component. A top surface of the lower portion is positioned below a top surface of the first component. A top surface of the upper portion is adjacent to the top surface of the first component such that a gap is defined along the lower portion of the second component beneath the top surfaces of the first component and the upper portion of the second component. The method includes filling the gap with an adhesive, and then compressing a pad toward the adhesive such that a continuous top surface of the adhesive extends between the top surfaces of the first component and the upper portion of the second component.

A system for forming a tray assembly for holding batteries for a vehicle. The system includes a first component and a second component positioned adjacent to the second component. The second component has a lower portion positioned adjacent to the first component and an upper portion spaced from the first component. A top surface of the lower portion is positioned below a top surface of the first component. A top surface of the upper portion is adjacent to the top surface of the first component such that a gap is defined along the lower portion of the second component beneath the top surfaces of the first component and the upper portion of the second component. An adhesive is located in the gap. A pad is configured to be compressed toward the adhesive such that a continuous top surface of the adhesive extends between the top surfaces of the first component and the upper portion of the second component.

According to the above, the resulting seal in the gap between the battery tray components is smooth, leak tight, simple and inexpensive to make.

### BRIEF DESCRIPTION OF THE DRAWINGS

These and other advantages of the present disclosure will be more readily understood by reference to the following description in combination with the accompanying drawings wherein:

FIG. 1 is a perspective view of an embodiment of a battery tray assembly, according to an aspect of the disclosure;

FIG. 1A is a magnified view of a corner of the battery tray assembly of FIG. 1;

FIG. 2A is a side, cross-sectional view of a meeting of a first component and a second component of the battery tray assembly, illustrating a top surface of the first component being arranged substantially coplanar with a top surface of an upper portion of the second component;

FIG. 2B is a side, cross-sectional view of the meeting of the first and second components shown in FIG. 2A, now including an adhesive in a gap between the first and second components;

FIG. 2C is a side, cross-sectional view of an alternate meeting of the first component and the second component of the battery tray assembly, illustrating the top surface of the first component being arranged non-coplanar with the top surface of the upper portion of the second component;

FIG. 2D is a side, cross-sectional view of the meeting of the first and second components shown in FIG. 2C, now including an adhesive in a gap between the first and second components;

FIG. 3 is a perspective view of a clamping machine used for applying a pad against a film overlying the adhesive in the gap between the first and second components of the battery tray assembly;

FIG. 3A is a magnified view of the clamping machine of FIG. 3 including the pad in accordance with a first aspect;

FIG. 3B is a magnified view of the clamping machine of FIG. 3 including the pad in accordance with a second aspect;

FIG. 4 is a schematic diagram of stations used for assembling a battery tray assembly, according to an aspect of the disclosure;

FIG. 5A is a perspective view illustrating a step of a method in which the gap is filled with the adhesive in accordance either planar or non-coplanar arrangement of the first and second components;

FIG. 5B is a perspective view illustrating a subsequent step of the method in which a film is positioned over the top surface of the first component, the adhesive and the top surface of the upper portion of the second component in accordance with either planar or non-coplanar arrangement of the first and second components;

FIG. 5C is a perspective view illustrating a subsequent step of the method in which the film is compressed downwardly against the top surface of the first component, the adhesive and the top surface of the upper portion of the second component by the pad in accordance with the first aspect;

FIG. 5D is a perspective view illustrating the subsequent step of the method shown in FIG. 5C but with the pad in accordance with the second aspect;

FIGS. 6A-6D are side, cross-sectional views illustrating steps of the method of sealing the gap between first and second components arranged in the substantially coplanar relationship, and according to use of the first aspect of the pad;

FIG. 6E is a front, cross-sectional view taken from 6E-6E of FIG. 6D;

FIG. 6F is a further side, cross-sectional view of another step of the method of sealing the gap of FIGS. 6A-6D in which the first aspect of the pad is removed from the film;

FIG. 6G is a perspective view of another step of the method of sealing the gap of FIGS. 6A-6F illustrating a continuous top surface of the adhesive extending between the top surface of the first component and the top surface of the upper portion of the second component;

FIGS. 7A-7D are side, cross-sectional views illustrating steps of the method of sealing the gap between the first and second components arranged in the alternate non-coplanar relationship, and according to use of the second aspect of the pad;

FIG. 7E is a further side, cross-sectional view illustrating the second aspect of the pad flexing while being compressed against the film to accommodate the non-coplanar arrangement between the first and second components;

FIG. 7F is a further side, cross-sectional view of another step of the method of sealing the gap of FIGS. 7A-7E in which the second aspect of the pad is removed from the film;

FIG. 7G is a perspective view of another step of the method of sealing the gap of FIGS. 7A-7F illustrating a continuous top surface of the adhesive extending between the non-coplanar arrangement of the top surface of the first component and the top surface of the upper portion of the second component;

FIG. 8 is a perspective view illustrating the second aspect of the pad being interconnected to a clamp bracket of the clamping machine via a pair of pad mounting brackets, a plurality of biasing springs and a plurality of fasteners;

FIG. 9 is an exploded view of FIG. 8;

FIG. 10 is a cross-sectional view of the second aspect of the pad being interconnected to the clamp bracket; and

FIG. 11 is a flow diagram of a method for making a battery tray assembly, according to an aspect of the disclosure.

### DETAILED DESCRIPTION OF THE ENABLING EMBODIMENTS

Example embodiments will now be described more fully with reference to the accompanying drawings. In general, the subject embodiments are directed to a system and method for making battery tray assemblies. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Referring to the Figures, wherein like numerals indicate corresponding parts throughout the several views, embodiments of a tray assembly 20 for holding batteries, and systems and methods for making the tray assembly 20 are shown. According to the preferred embodiment, the tray assembly 20 is used for holding and protecting batteries in electric vehicles like automobiles, but could be used for holding batteries in other applications. Furthermore, the systems and methods could be used to form trays or similar structures used for other purposes.

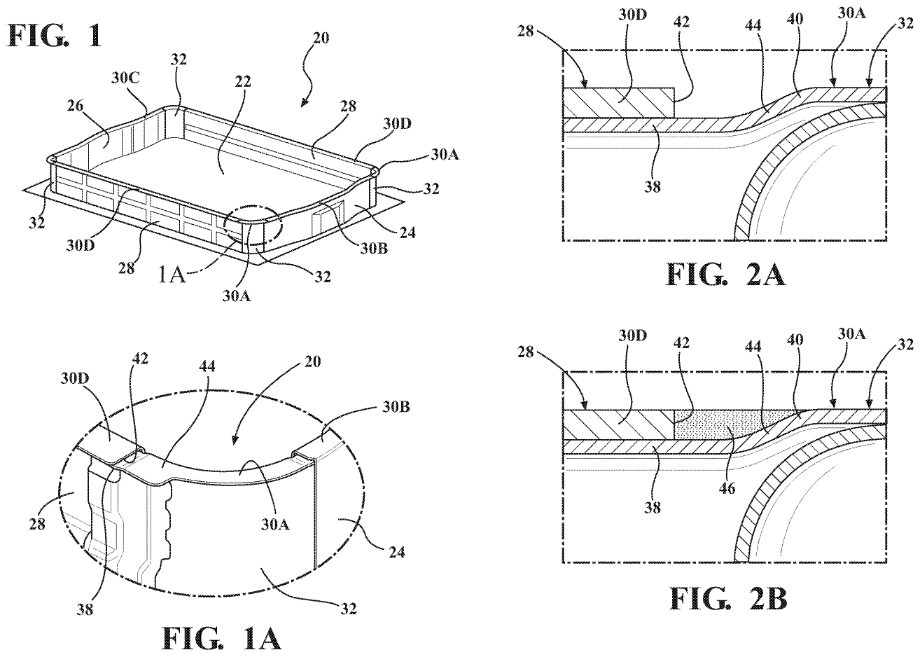

With reference to FIGS. 1 and 1A, the tray assembly 20 includes a base 22 that is substantially planar and generally has a rectangular shape with four corners. A front wall 24 and a rear wall 26 each extend upwardly from opposing edges of the base 22 in spaced and parallel relationship with one another. A pair of side walls 28 extend upwardly from opposing edges of the base 22 in spaced and parallel relationship with one another. The side walls 28 span substantially an entire distance between the front and rear walls 24, 26. A flange 30A, 30B, 30C, 30D extends outwardly from a top of each of the front, rear and side walls 24, 26, 28. According to embodiments, the tray assembly 20 could have other shapes, e.g., an oval or circle.

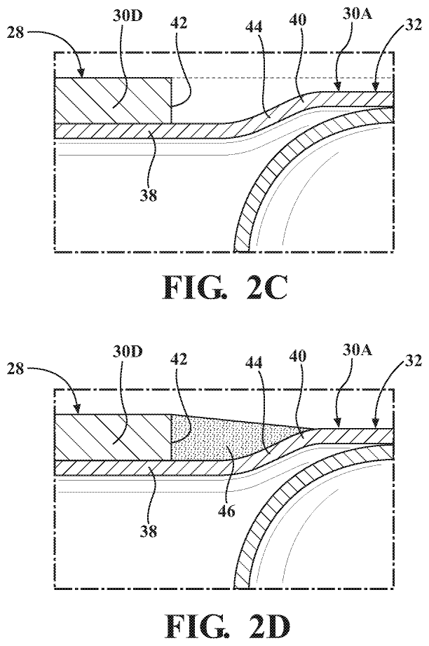

Four corner segments 32 each extend upwardly from one of the corners of the base 22. The corner segments 32 each span a distance between one of the side walls 28 and one of the front or rear walls 24, 26. As best shown in FIG. 1A, both ends of the flange 30A of each of the corner segments 32 may be positioned vertically beneath a pair of the flanges 30B, 30C, 30D of the respectively adjacent front, rear and side walls 24, 26, 28. More particularly, FIGS. 2A-2D illustrate a schematic example of a union between the flange 30A of one of the corner segments 32 and the flange 30D of one of the side wall segments 28. Although the flanges 30A, 30D of a corner segment 32 and a side wall segment 28 are shown in these Figures, the same teachings may be applied for the overlapping flanges 30 of any portions. Furthermore, the same teachings may be applied to other overlapping components. As will be discussed in further detail below, FIGS. 2A and 2C presents a union between the corner and side wall flanges 30A, 30D prior to execution of the subject method, and FIGS. 2B and 2D illustrates the same union after the method has been carried out.

With continued reference to FIGS. 2A-2D, the flange 30A of the corner segment 32 has a lower portion 38 positioned adjacent to the side wall 28, and an upper portion 40 that is laterally spaced from the side wall 28. A top surface of the lower portion 38 is positioned below a top surface of the side wall 28, and a top surface of the upper portion 40 is adjacent to and laterally spaced from the top surface of the side wall 28. The flange 30A of the corner segment 32 slopes upwardly between the lower and upper portions 38, 40 along a ramp 44. A gap 42 is defined vertically above the lower portion 40 of the corner segment 32 and laterally between an edge of the side wall 28 and the ramp 44. FIGS. 2B and 2D illustrate the flanges 30A, 30D after the subject method has been carried out. At this point, the gap 42 is filled with an adhesive 46, and a continuous top surface of the adhesive 46 extends between the top surfaces of the flanges 30A, 30D.

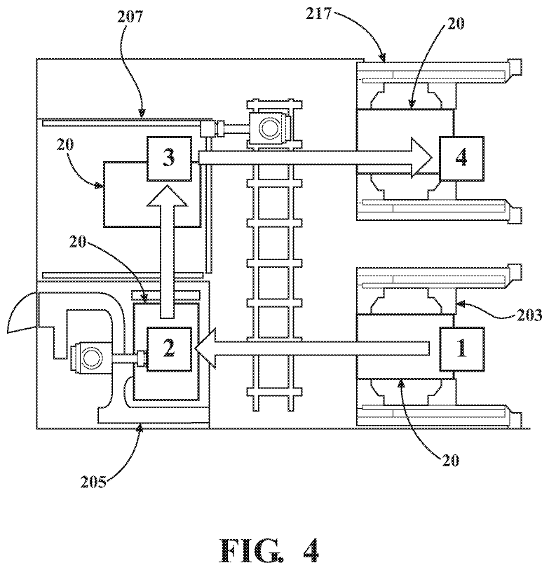

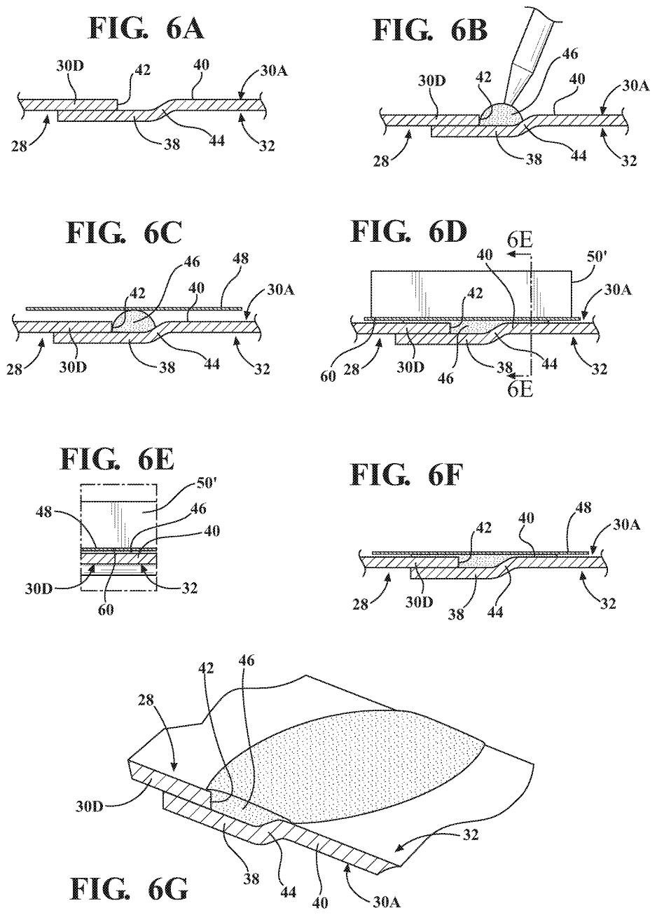

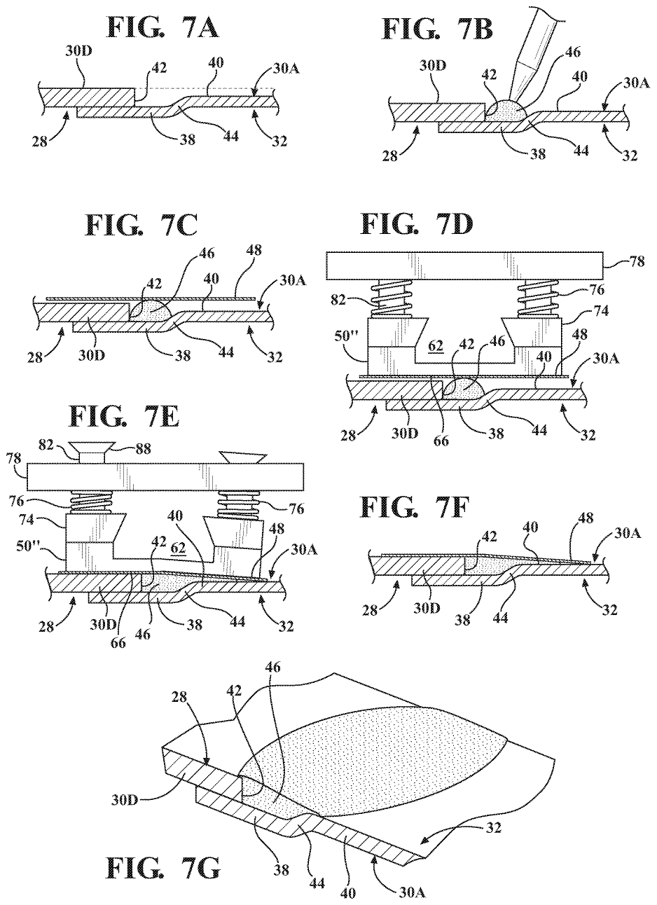

FIG. 11 schematically presents a method 200 of making a battery tray assembly 20 according to embodiments. Furthermore, FIG. 4 presents a schematic diagram of work stations 203, 205, 207, 217 that may be used in association with the subject method. As shown in FIGS. 6A and 7A, the method includes 202 assembling a tray 20 into an initial position in which a first component 30D (e.g., a flange of a front, rear or side wall 24, 26, 28) is positioned adjacent to a second component 30A (e.g., a flange of a corner segment 32) as described above. Once the tray assembly 20 is in the initial position, the method may include the step of 204 electro coating (E-coating) the tray assembly 20 at an e-coating station 203 (shown in step 1 of FIG. 4), which may serve as a protective coating. As shown in step 2 of FIG. 4, the method continues with 206 removing the tray assembly 20 from the e-coating station 203 and moving it to an adhesive application station 205.

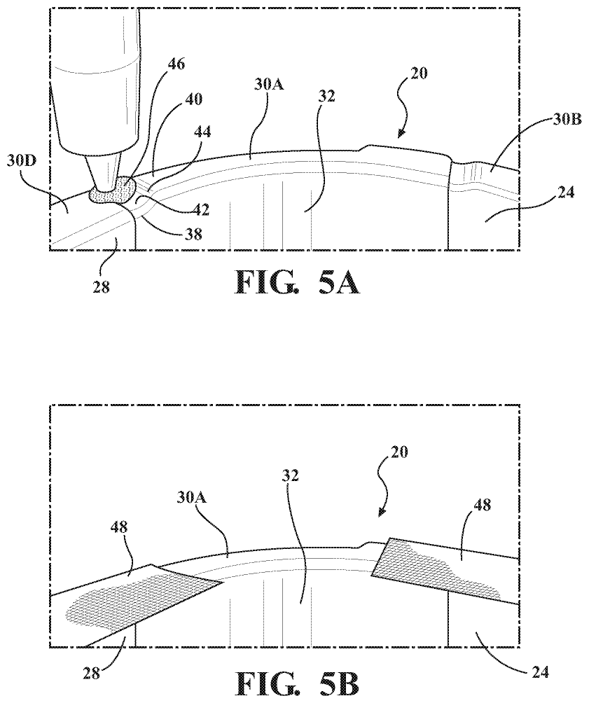

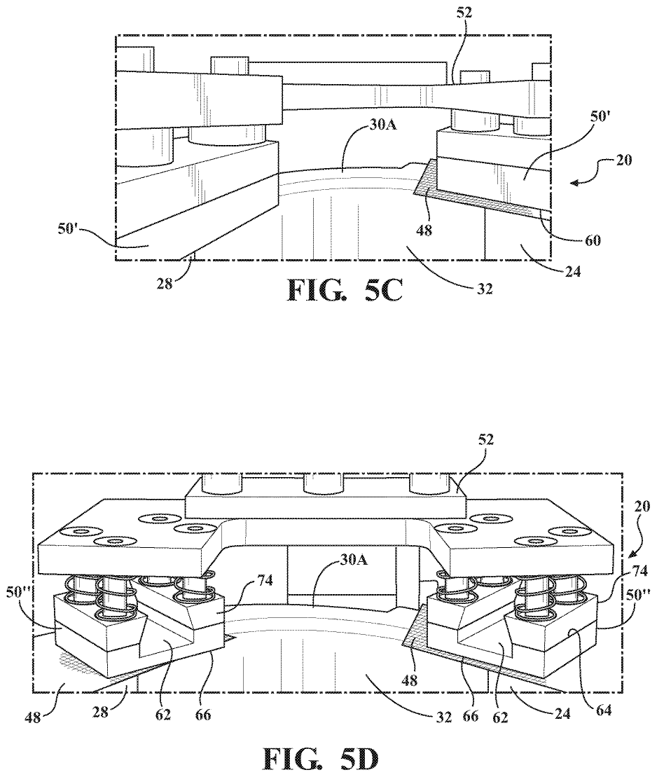

As best shown in FIGS. 2A and 6A, the top surface of the first component 30D (e.g., a flange of the front, rear or side wall 24, 26, 28) can be substantially coplanar with the top surface of the upper portion 40 of the second component 30A (e.g., flange of a corner segment 32). Alternatively, as best shown in FIGS. 2C and 7A, manufacturing variations in production parts can result in the top surface of the first component 30D (e.g., a flange of a front, rear or side wall 24, 26, 28) being arranged non-coplanar and misaligned with (e.g., slightly higher or lower than) the top surface of the upper portion 40 of the second component 30A (e.g., a corner segment 32)—as shown by the dotted lines in FIGS. 2c and 7A. In either planar or non-coplanar arrangement, as shown in FIGS. 5A, 6B, and 7B, the method continues with 208 filling the gap 42 with an adhesive 46 at the adhesive application station 205. As shown in step 3 of FIG. 4, the method continues with moving the tray assembly 20 to a flattening station 207. As shown in FIGS. 5B, 6C and 7C, the method continues with 212 positioning a film 48 over the top surfaces of the first component 30D, the adhesive 46 and the top surface of the upper portion 40 of the second component 30A. According to the preferred embodiment, the film 48 is polytetrafluoroethylene (PTFE) coated fiberglass, but other types of films fall within the scope of the present disclosure.

As shown in FIGS. 5C, 5D, 6D, and 7D-7E, in either planar or non-coplanar arrangement, the method continues with 214 compressing the film 48 downwardly against the adhesive 46 and the top surfaces of the first component 30D and upper portion 40 of the second component 30A with a pad 50 such that a continuous top surface of the adhesive 46 ultimately extends between the top surfaces of the flange 30D of side wall 28 and the upper portion 40 of the flange 30A of the corner segment 32 to fill the gap 42 and secure the side wall 28 and corner segment 32 (See e.g., FIGS. 6F-6G and 7F-7G).

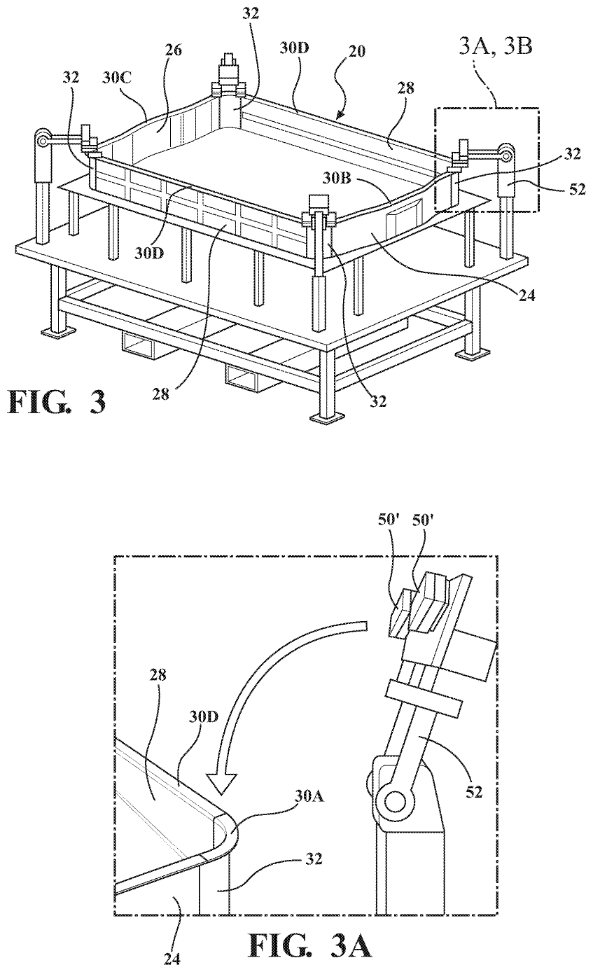

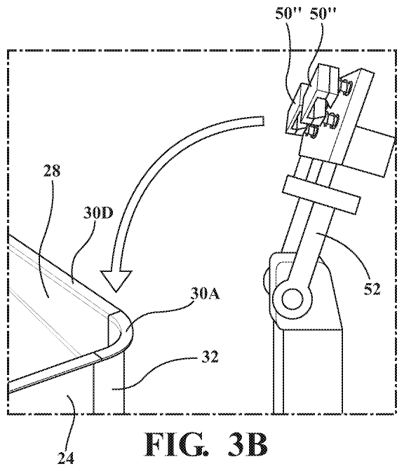

According to the preferred embodiment, the pad 50 is a 70 A durometer pad, but other types of pads fall within the scope of the present disclosure. As shown in FIGS. 3A-3C, a clamping machine 52 like a robotic arm may be configured to position and press the pad 50 against the film 48 and remove the pad 50.

As best illustrated in FIGS. 5C, 6D and 6E, in accordance with a first aspect, the pad 50′ has a planar bottom surface 60 such that when utilized with the substantially coplanar top surfaces of the first and second components 30A, 30D, the compressing of the pad 50′ towards the adhesive 46 results in the continuous top surface of the adhesive 46 becoming substantially planar with the top surfaces of the first component 30D and the upper portion 40 of the second component 30A. (See e.g., FIGS. 2B and 6G). As shown in FIGS. 5C and 6D, in an arrangement, the pad 50′ can have a quadrilateral cross-sectional shape (e.g., rectangular, square, or the like) to provide the planar bottom surface 60. However, other shapes of the pad 50′ can be utilized without departing from the disclosure.

As best illustrated in FIGS. 5D, 7D-7E, and 8-10, in accordance with a second aspect, the pad 50″ has a central cavity 62 which extends downwardly from and is open to a top pad surface 64 such that the pad 50″ is configured to flex while being compressed by the clamping machine 52 for accommodating any non-coplanar top surfaces present between the first component 28 and the upper portion 40 of the second component 32. (See FIG. 7E). Put another way, the second aspect of the pad 50″ allows a bottom compression surface 66 to extend between and conform to the non-coplanar top surfaces during compression, by way of disposing the central cavity 64 in a middle section of the pad 50″, which results in a smooth and blended transition of the continuous top surface of the adhesive 46 between the non-coplanar top surfaces after compression of the pad 50″. Thus, the second aspect of the pad 50″ provides a flush, continuous top surface of the adhesive 46, even when non-coplanar top surfaces are laterally spaced from one another on opposite sides of the gap 42. The durometer of the pad 50″ further allows for conformity and ensures a smooth transition of adhesive 46 to substrate.

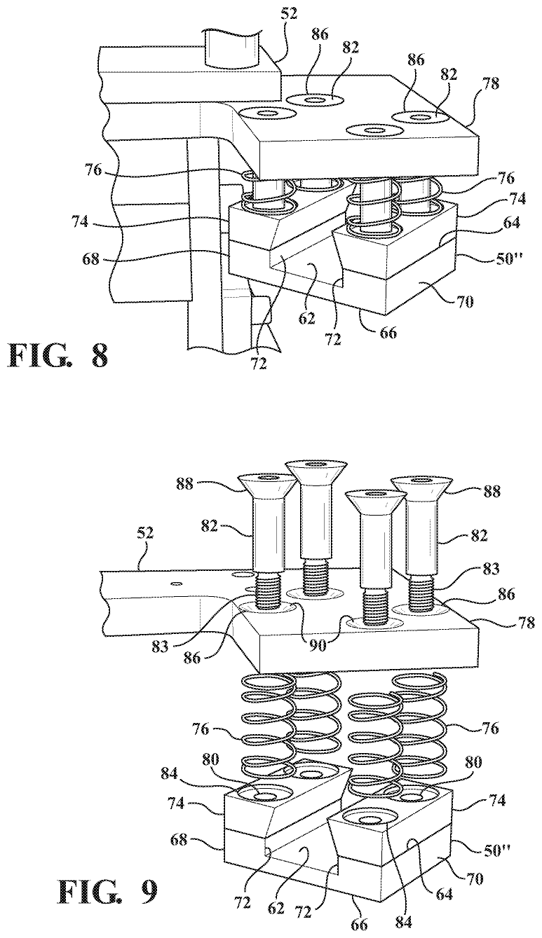

As best illustrated in FIGS. 8-10, the pad 50″ extends from a first pad end 68 (for being disposed in compressed relationship with a top surface of the first component 30D) to a second pad end 70 (for being disposed in compressed relationship with a top surface of the second component 30A). A pair of pad walls 72 are disposed adjacent a respective one of the first or second pad ends 68, 70 and extend upwardly from the bottom compression surface 66 to the top pad surface 64 on opposite sides of the central cavity 62. Each of the pad walls 72 are separately biased towards the bottom compression surface 66 for maintaining consistent pressure and conformity between any non-coplanar top surfaces of the first and second components 30A, 30D during compression of the pad 50″. More specifically, a pad mounting bracket 74 is secured to the top pad surface 64 of each pad wall 72 and at least one biasing spring 76 extends between the pad mounting bracket 74 and a clamp bracket 78 of the clamping machine 52 for applying the biasing force to each of the pad walls 72. The at least one biasing spring 76 preferably includes a pair of biasing springs 76 for each pad mounting bracket 74 to more evenly distribute the biasing force on the respective pad wall 72.

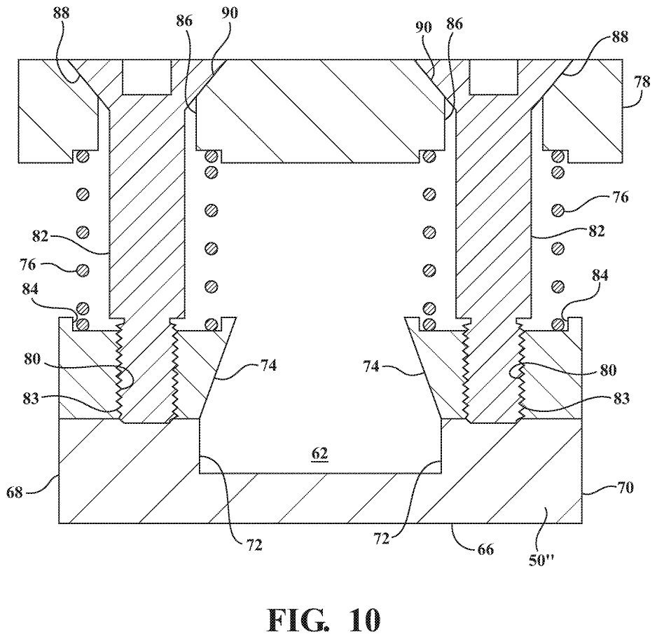

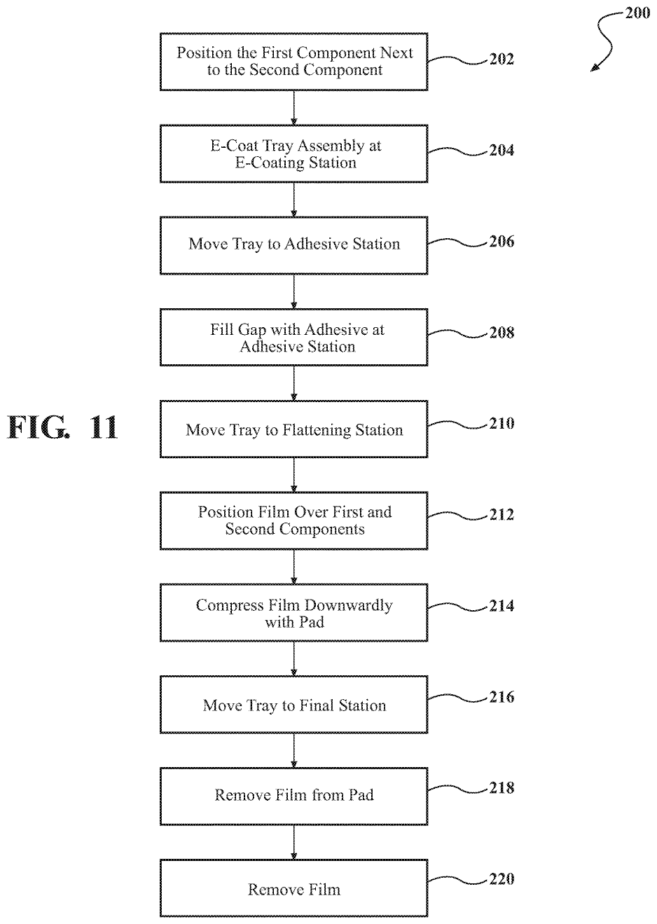

In this arrangement, each pad mounting bracket 74 defines a pair of threaded bores 80 disposed in spaced relationship with one another, and a pair of fasteners (e.g., shoulder screws) 82 extend downwardly from the clamp bracket 78, through a respective one of the biasing springs 78 and terminating at a threaded tip 83 disposed into threaded engagement with a respective one of the threaded bores 80 for securing the pad 50″ to the clamp bracket 78 of the clamping machine 52. The fasteners 82 also retain the biasing springs 76 between the pad mounting bracket 74 and the clamp bracket 78 and thus assist in transferring the biasing force to the pad 50″. As best illustrated in FIG. 9, the pad mounting bracket 74 can also define a spring seat 84 extending around each threaded bore 80 for seating a bottom end of each biasing spring 76. The clamp bracket 78 defines a plurality of fastener holes 86 each for receiving a respective one of the fasteners (e.g., shoulder screws) 82. As best illustrated in 7E, the fasteners 82 are free to travel upwardly through fastener holes 86 during compression of the pad 50″, and as the biasing springs 76 are compressed between the pad mounting bracket 74 and the clamp bracket 78. Once the pad 50″ is released from being in compression with the top surfaces of the first and second components, the biasing springs 76 bias the pad mounting bracket 74 and the pad 50″ attached thereto back to the home position, during which the shoulder screws 82 travel downwardly through the fastener holes 86. As best illustrated in FIG. 10, a flared head portion 88 of each shoulder screw 82 ultimately engages a stop 90 defined by the fastener holes 86 to limit downward travel of the shoulder screw 82 and the pad 50″ ultimately attached thereto. Thus, the plurality of shoulder screws 82 allow for stability of the pad 50″ and assist in providing a consistent return of the pad 50″ to the home position upon a release of compression on the pad 50″. As will be appreciated in view of the aforementioned disclosure, the use of the biasing springs 76 and shoulder screws 82 with the second aspect of the pad 50″ having a central cavity 62 allows the pad 50″ to self-locate the bottom compression surface 66 across the non-coplanar top surfaces and apply an even amount of pressure on the first and second pad ends 70, 72. Thus, the first and second pad ends 70, 72 can feather the adhesive 46 along the top surfaces of the respective first and second components, while allowing the middle portion of the pad 50″ to blend the non-coplanar surfaces, by way of the flexing and bending provided by the presence of the central cavity 62.

In accordance with either aspect of the pad, as shown in FIGS. 6F and 7F, the method continues with 216 moving the tray assembly 20 to a final station 217, and 218 removing the pad 50 from the film 48 and curing the adhesive 46. As shown in FIGS. 6G and 7G, the method continues with 220 removing the film 48. Once the film 48 is removed, a continuous top surface of the adhesive 46 is provided between the first component 28 and the second component 32 with the first and second components 28, 32 securely connected to one another. This method may be used simultaneously, or separately, at any number of corners or other features on the battery tray assembly 20.

According to the above, the subject system and method provide a seal between components of the battery tray 20 that is smooth and leak tight, and simple and inexpensive to make. The subject system allows the adhesive 46 to cure to a desired profile, prevents adhesive sag, and the film 48 can cleanly and easily be removed once the adhesive 46 is cured. Furthermore, the entire process may be fully or partially automated, including using the clamping machine 52 to automatically press the pad 50 against the film 48.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in that particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or later, or intervening element or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to described various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in any embodiment, even if not specifically shown or described. The same may also be varied in many ways. Such variations are not to be regarded as a departure from the disclosure, and all such modifications are intended to be included within the scope of the disclosure.

What is claimed is:

1. A method for making a tray assembly, comprising:
providing a first component and a second component, with the first component positioned adjacent to the second component, wherein the second component has a lower portion positioned adjacent to the first component and an upper portion spaced from the first component, wherein a top surface of the lower portion is positioned below a top surface of the first component, and wherein a top surface of the upper portion is adjacent to the top surface of the first component such that a gap is defined along the lower portion of the second component beneath the top surfaces of the first component and the upper portion of the second component;
filling the gap with an adhesive; and
compressing a pad toward the adhesive such that a continuous top surface of the adhesive extends between the top surfaces of the first component and the upper portion of the second component.

2. The method as set forth in claim 1, wherein the top surface of the upper portion is substantially coplanar with the top surface of the first component, and the compressing of the pad towards the adhesive is such that the continuous top surface of the adhesive becomes substantially planar with the top surfaces of the first component and the upper portion of the second component.

3. The method as set forth in claim 1, wherein the top surface of the upper portion is arranged non-coplanar with the top surface of the first component, and the compressing of the pad towards the adhesive is such that the continuous top surface of the adhesive blends and transitions between the top surfaces of the first component and the upper portion of the second component.

4. The method as set forth in claim 3, wherein the pad includes a continuous bottom compressing surface and a central cavity extending downwardly from and being open to an opposite top surface of the pad such that the pad is configured to flex during the compressing step to accommodate the non-coplanar top surfaces of the first component and the upper portion of the second component.

5. The method as set forth in claim 1, further including positioning a film over the top surface of the first component, the adhesive and the top surface of the upper portion of the second component prior to compressing the pad against the adhesive, such that the pad is compressed against the film to flatten the adhesive.

6. The method as set forth in claim 2, further including removing the film after compressing the pad against the film.

7. The method as set forth in claim 2, wherein the film is a polytetrafluoroethylene coated fiberglass.

8. The method as set forth in claim 1, wherein the battery tray assembly includes a plurality of walls, and a plurality of corner segments each positioned between two of the walls, and wherein the first component is a flange located at a top of one of the walls, and wherein the second component is a flange located at a top of one of the corner segments.

9. The method as set forth in claim 1, wherein the pad is a 70 A durometer pad.

10. A system for forming a tray assembly for holding batteries for a vehicle, comprising:
a first component and a second component positioned adjacent to the second component;
the second component having a lower portion positioned adjacent to the first component and an upper portion spaced from the first component, wherein a top surface of the lower portion is positioned below a top surface of the first component, and wherein a top surface of the upper portion is adjacent to the top surface of the first component such that a gap is defined along the lower portion of the second component beneath the top surfaces of the first component and the upper portion of the second component;
an adhesive located in the gap; and
a pad configured to be compressed toward the adhesive such that a continuous top surface of the adhesive extends between the top surfaces of the first component and the upper portion of the second component.

11. The system as set forth in claim 10, wherein the top surface of the upper portion is substantially coplanar with the top surface of the first component, and wherein the continuous top surface of the adhesive is substantially planar with the top surfaces of the first component and the upper portion of the second component.

12. The system as set forth in claim 11, wherein the pad having a quadrilateral cross-sectional shape.

13. The system as set forth in claim 10, wherein the top surface of the upper portion is arranged non-coplanar with the top surface of the first component, and the continuous top surface of the adhesive blends and transitions between the top surfaces of the first component and the upper portion of the second component.

14. The system as set forth in claim 13, wherein the pad includes a continuous bottom compressing surface and a central cavity extending downwardly from and being open to an opposite top surface of the pad such that the pad is configured to flex while being compressed to accommodate the non-coplanar top surfaces of the first component and the upper portion of the second component.

15. The system as set forth in claim 14, wherein the pad includes a pair of pad walls disposed on opposite sides of the central cavity and each being separately biased towards the bottom compression surface for maintaining consistent pressure and conformity of the continuous bottom compressing surface with the non-coplanar top surfaces while the pad is being compressed.

16. The system as set forth in claim 15, further comprising:
a pair of pad mounting brackets each secured to the top pad surface of a respective one of the pad walls,
at least two biasing springs each extending between a respective one of the pad mounting brackets and a clamp bracket of a clamping machine;
at least two fasteners each extending downwardly from the clamp bracket, through a respective one of the biasing springs, and into fastened engagement with a respective one of the pad mounting brackets; and
the clamp bracket defining at least two fastener holes each for receiving a respective one of the fasteners and allowing the fasteners to freely travel upwardly through their respective fastener holes while the pad is being compressed.

17. The system as set forth in claim 10, further including a film positioned over the top surface of the first component, the adhesive and the top surface of the upper portion of the second component for being compressed by the pad against the adhesive to flatten the adhesive.

18. The system as set forth in claim 10, further including a plurality of walls, and a plurality of corner segments each positioned between two of the walls, wherein the first component is a flange located at a top of one of the walls, and wherein the second component is a flange located at a top of one of the corner segments.

19. The system as set forth in claim 10, wherein the film is a polytetrafluoroethylene coated fiberglass.

20. The system as set forth in claim 10, wherein the pad is a 70 A durometer pad.
